(19) United States
(12) Patent Application Publication
(10) Pub. No.: US 2022/0338455 A1
(43) Pub. Date: Oct. 27, 2022

(54) FLY FISHING LEADER HOLDING DEVICE

(71) Applicant: ASPIGON 180 CC, Randburg (ZA)

(72) Inventor: Greg CARSTENS, Knysna (ZA)

(73) Assignee: ASPIGON 180 CC, Randburg (ZA)

(21) Appl. No.: 17/700,573

(22) Filed: Mar. 22, 2022

(30) Foreign Application Priority Data
Apr. 21, 2021 (ZA) 2021/02638

(51) Int. Cl. A01K 87/04

(52) U.S. Cl. CPC A01K 87/04

(57) ABSTRACT

A fishing line holding device includes a body and a retention formation on the body which is configured to be engaged with a portion of a fishing line so that the fishing line is thereby anchored to the retention formation. The retention formation may include a section which projects from the body and around which, in use, a portion of the fishing line is looped, and a restraining formation on the section which prevents the looped fishing line from being moved off the section.

### BACKGROUND OF THE INVENTION

The invention relates generally to a fishing rod assembly and to a device for holding a fishing line.

A fishing rod used, for example, for fly-fishing includes a rod with spaced apart line guides. A reel is mounted to the rod and a line, drawn from the reel, is passed through the line guides. A leader line is attached, using a connector, to an end of the line. A locknut is normally used to keep the reel in position on the rod. If the locknut is inadvertently loosened then the reel can become disengaged from the rod. possibly resulting in damage to the reel. Another unwanted occurrence is that the connector between the leader line and the line could be pulled through the line guides towards the reel and become lodged between one of the line guides and the reel. This frustrating event can also lead to rod damage. Additionally if suitable care is not exercised the line and the leader line can become entangled with the rod, the reel, one of the line guides or some external object.

An object of the present invention is to address at least to some extent the aforementioned issues.

### SUMMARY OF THE INVENTION

The invention provides in a first instance a fishing line holding device which comprises a body and a retention formation on the body which is configured to be engaged with a portion of a fishing line so that the fishing line is thereby anchored to the retention formation.

Preferably the retention formation includes a section which projects from the body and around which, in use, a portion of the fishing line is looped, and a restraining formation on the section which prevents the looped fishing line from being moved off the section.

The restraining formation may take on any suitable shape but preferably is in the form of a crosspiece.

The holding device may comprise an annular body which is formed from an elastically deformable material and which is configured to be engaged with an operative region of a fishing rod, extending circumferentially and in a tensioned state around the fishing rod. The section projects from the body and is positioned so that, in use, a portion of a fishing line can be looped around the section.

One preferred application of the invention is in respect of a fishing rod assembly which includes a rod with spaced apart line guides, a reel which is mounted to an operative region of the rod, a line which extends from the reel through the line guides and a leader line which is connected to an end of the line by means of a connector. A locknut is used to maintain the reel in position on the operative region. The annular body of the holding device is then frictionally engaged with the operative region and is brought into contact with the locknut thereby to prevent unwanted movement of the locknut.

With this arrangement the fishing line holding device performs two functions, namely that when a portion of the fishing line is engaged with the retention formation the fishing line is then held in position relative to the rod. This addresses problems which might arise due to unwanted movement of the line, the leader line or the connector. A second benefit is that, as the holding device abuts the locknut, unwanted movement of the locknut is prevented. The reel then remains firmly and securely mounted to the rod.

In a modified form of the invention the fishing rod assembly includes a reel seat which is located at the operative region. The reel is detachably mounted to the reel seat and the locknut is threadedly engaged with a complementary thread at the operative region and is actuable thereby to maintain the reel mounted to the reel seat. A fishing line holding device is located on the reel seat positioned between the locknut and an adjacent end of the rod. In this embodiment the fishing line holding device is preferably fixed to, or is formed integrally with, the reel seat.

### BRIEF DESCRIPTION OF THE DRAWINGS

The invention is further described by way of examples with reference to the accompanying drawings in which:

FIG. 1 is an end view of a holding device according to one form of the invention;

FIG. 1A is a side view of the holding device shown in FIG. 1;

FIG. 2 is a perspective view of a fishing rod assembly which includes a holding device of the kind shown in FIG. 1;

FIG. 3 is similar to FIG. 2, but illustrating how a portion of a fishing line which extends from a reel is engaged with the holding device;

FIG. 4 shows on an enlarged scale a portion of the fishing rod assembly which is encircled in dotted outline in FIG. 2; and

FIG. 5, which is similar to FIG. 3, illustrates a different embodiment of the invention.

### DETAILED DESCRIPTION OF THE INVENTION

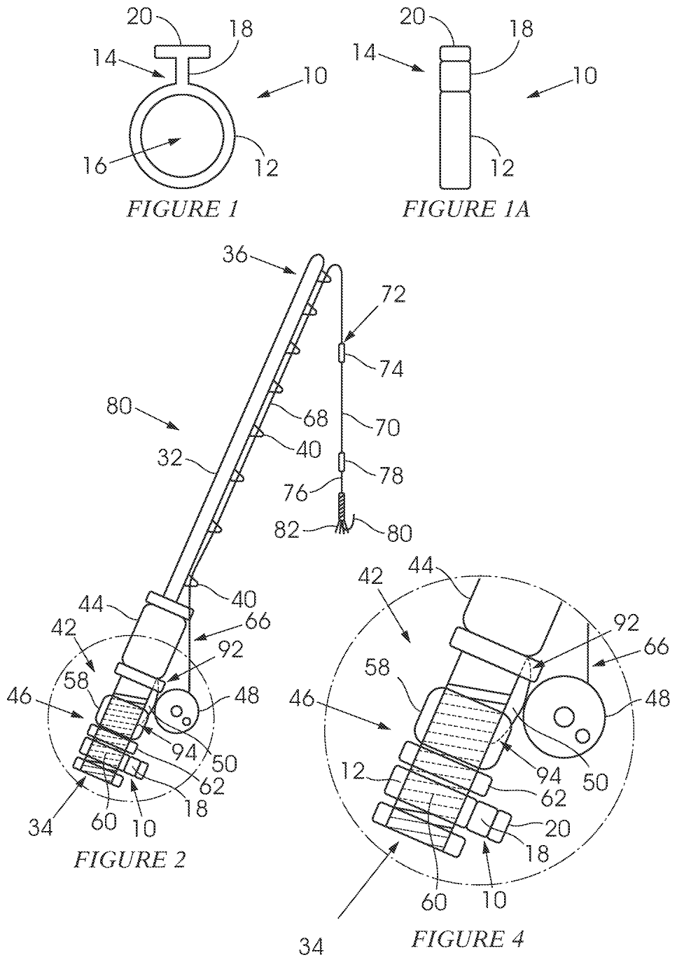

FIGS. 1 and 1A of the accompanying drawings are end and side views respectively of a holding device 10 according to the invention.

The holding device 10 includes an annular body 12 and a retention formation 14. The body 12 encloses a hole 16. The retention formation 14 comprises a section 18 which extends from the body and a restraining formation 20 at one end of the section 18. In this example the restraining formation 20 is in the form of a crosspiece and, consequently, the retention formation has a T-shape.

The holding device 10 is integrally moulded from a suitable resiliently deformable material such as a medical grade silicone.

FIG. 2 depicts in perspective view a fishing rod assembly 30 according to one form of the invention. The fishing rod assembly 30 includes a rod 32 with a first end 34 and an opposed second end 36. A plurality of line guides 40 are fixed to the rod at spaced apart intervals.

The first end 34 embodies an operative region 42 with a handle 44 and structure 46 which is configured so that a reel 48 can be mounted to the operative region. The reel 48 is of a conventional form and includes a foot 50 with first and second shaped end portions 54 and 56 which are inserted into corresponding recesses in the handle 44 and in a member 58 which is movably engaged with a part of the operative region which carries a thread 60. A locknut 62, engaged with the thread 60, is actuable to move the member 58 towards the handle 44 so that the foot 50 of the reel is firmly held in position.

The holding device 10 is engaged with the operative region 42 between the locknut 62 and the first end 34. The annular body 12 is stretched so that it can be positioned around a part of the rod, which extends through the hole 16, adjacent the first end 34, and is then moved so that it abuts the locknut 62. As the holding device is made from a resiliently deformable material the annular body can be stretched so that it can be positioned as indicated. The annular body is then kept in that tensioned state—this ensures that the body 12 remains in position tightly engaged with the thread 60 adjacent the locknut 62. The likelihood that the locknut 62 can inadvertently be moved in such a way that the reel 48 becomes detached from the operative region 42 is for all practical purposes eliminated.

A fishing line 66 is coiled on the reel 48 in a conventional manner. The fishing line includes a line 68 which is usually of considerable length and which is passed through the line guides 40. For fly-fishing a leader line 70 is connected to an end 72 of the line 68 by means of a connector 74 which is of known form and construction. The leader line 70 is connected to an end of a tippet 76 by means of a connector 78. A fishing hook 80 and a fly 82 are connected to an opposing end of the tippet. This form of construction is known and is not further elaborated on herein.

FIG. 4 shows on an enlarged scale a portion of the fishing rod assembly 30 depicted in FIG. 2. The annular body 12 is in contact with the locknut 62 which in turn abuts the member 58—as explained this ensures that the reel is kept firmly in position and inadvertent movement of the locknut 62 along the thread 60, is prevented. The section 18 of the holding device 10 is positioned so that it more or less underlies the reel 48. The line 68 extends through the line guides 40 and is not attached to the holding device 10.

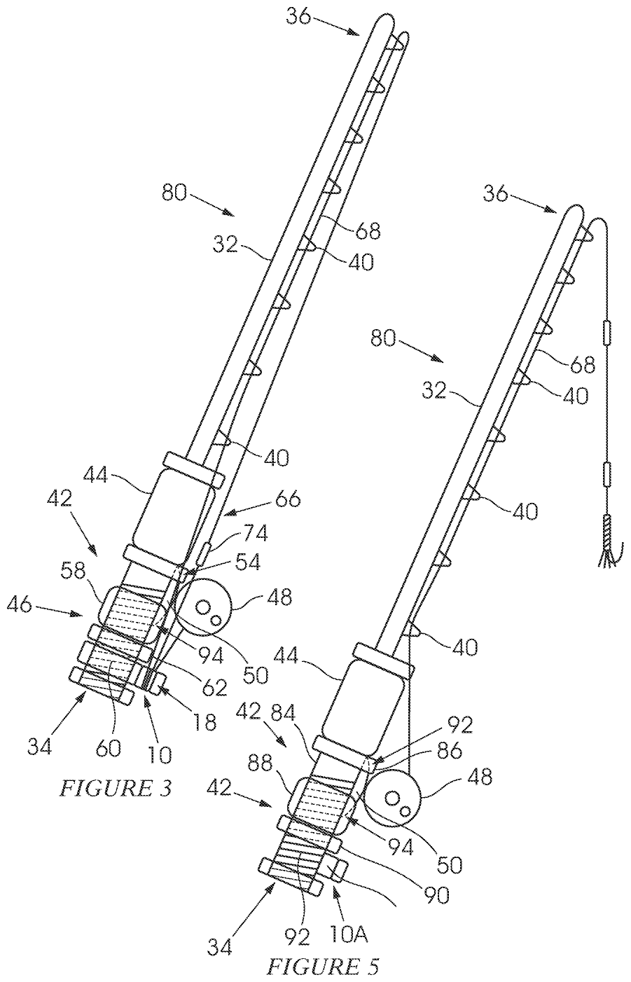

FIG. 3 shows that a portion of the line 66, possibly including the leader line 70 and the tippet 76, is looped around the section 18. The reel 48 is actuated to keep the remainder of the line 68 which passes through the line guides 40 and which then returns from the second end 36 of the rod, to the section 18, in a tensioned state. The looping of the line around the section 18 frictionally locks the line to the section 18 and the issues referred to in the preamble to this specification are in substance eliminated. The holding device 10 is positioned at the operative region 42 so that it can be easily accessed. It is a simple matter to loop the fishing line onto the holding device or, as required, to unwind the fishing line from the holding device. The holding device is such that it is unobtrusive and it does not interfere with normal usage of the fishing rod.

In the preceding description the holding device 10 is separate from the remainder of the fishing line assembly, and it can be attached to a fishing rod, or detached from the fishing rod, as required.

FIG. 5 illustrates an alternative fishing rod assembly 80. Where appropriate like reference numerals are used to designate like components and these like components are not further described herein.

The fishing rod assembly 80, at an operative region 42 adjacent the first end 34 of the fishing rod, includes a reel seat 84. A component 86 is located at one end of the reel seat 84 and a movable component 88 is positioned at an opposing end of the reel seat 84. A locknut 90, which is threadedly engaged with a thread 92 on the operative region 42, is actuable to move the component 88 towards the component 86. When the locknut is rotated in an opposing direction the component 88 can be moved away from the component 86. The fishing reel 48 has a foot 90 with opposed end regions 92 and 94 which are shaped to engage with recessed formations in the components 86 and 88 respectively. When the locknut 90 is tightened the component 88 is urged towards the component 86 and in this way the reel 48 is firmly secured to the operative region 42.

A holding device 10A is located between the first end 34 and the locknut 90. The holding device 10A is fixed in a semi-permanent or permanent fashion to the operative region 42 either at the thread 92 or at the reel seat 84 using one or more suitable fasteners. In a variation the holding device 10A is integrally formed with a part of the operative region 42 or with the reel seat 84. In other respects the holding device 10A is similar to and is used in the same way as the holding device 10.

In another form of the invention the annular body 12 of the holding device 10A is internally threaded so that the hole 16 can be threadedly engaged with the thread 92 on the operative region 42. This allows the holding device 10A to be threadedly moved into engagement with the locknut 90 thereby to prevent unwanted movement of the locknut. It is also possible for the holding device to function as, and in place of, a conventional locknut.

1. A fishing line holding device which comprises a body and a retention formation on the body which is configured to be engaged with a portion of a fishing line so that the fishing line is thereby anchored to the retention formation.

2. A fishing line holding device according claim 1 wherein the retention formation includes a section which projects from the body and around which, in use, a portion of the fishing line is looped, and a restraining formation on the section which prevents the looped fishing line from being moved off the section.

3. A fishing line holding device according to claim 2 wherein the restraining formation is in the form of a crosspiece.

4. A fishing line holding device according to claim 1 which is made from an elastically deformable material.

5. A fishing rod assembly which comprises a rod with a first end and an opposed second end, a plurality of spaced apart line guides mounted to the rod, a reel which is detachably mounted to an operative region of the rod at the first end, a fishing line which extends from the reel through the line guides, and a fishing line holding device according to claim 1 which is located at said operative region and wherein a portion of the fishing line is engageable with said retention formation thereby to hold the fishing line in position relative to the rod.

6. A fishing rod assembly according to claim 5 which includes a locknut which is threadedly engaged with a complementary thread at said operative region and which is actuable thereby to maintain the reel mounted to the rod, and wherein said fishing line holding device is releasably and frictionally engageable with said operative region, in contact with the locknut, thereby to prevent movement of the locknut.

7. A fishing rod assembly according to claim 5 wherein the rod includes a reel seat located at said operative region and said reel is detachably mounted to the reel seat, a locknut which is threadedly engaged with a complementary thread at the operative region and which is actuable thereby to maintain the reel mounted to the reel seat, and wherein said fishing line holding device is positioned between the locknut and the first end of the rod.

8. A fishing rod assembly according to claim 7 wherein the fishing line holding device is fixed to, or is formed integrally with, the reel seat.

9. A fishing rod assembly which includes a rod with a first end and an opposed second end, a plurality of spaced apart line guides mounted to the rod, a reel which is detachably mounted to an operative region of the rod at the first end, a fishing line which extends from the reel through the line guides, and a fishing line holding device which is located at said operative region and which includes a retention formation, and wherein a portion of the fishing line is engageable with the retention formation thereby to hold the fishing line in position relative to the rod.
